(19) United States
(12) Patent Application Publication
(10) Pub. No.: US 2008/0184311 A1
(43) Pub. Date: Jul. 31, 2008

(54) Electronic-mail reminder for an internet television program guide

(76) Inventors: Franklin E. Boyer, Cleveland, OK (US); Timothy B. Demers, Tulsa, OK (US); Bruce A. Blackwell, Broken Arrow, OK (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 11/894,710

(22) Filed: Aug. 20, 2007

Related U.S. Application Data
(63) Continuation of application No. 10/933,689, filed on Sep. 3, 2004.
Application No. 10/933,689 is a continuation of application No. 08/987,740, filed on Dec. 9, 1997, now abandoned.
Application No. 08/987,740 is a continuation-in-part of application No. 08/938,028, filed on Sep. 18, 1997, now abandoned.

(51) Int. Cl. H04N 5/445; G06F 13/00

(52) U.S. Cl. 725/51; 725/58

(57) ABSTRACT

An Internet television program guide electronic-mail (e-mail) reminder system is provided. The system allows a user at a multimedia system to order and receive e-mail message reminders of scheduled television events over the Internet. The user can order e-mail reminders after selecting a program from the program listings or by supplying [a program title directly] specific user program preferences without having to consult the program listings. The user can specify when and how often the reminders will be generated and received. If desired, the user can view a list of all currently requested e-mail reminders. Entries can be added to the list or the user can cancel a previously ordered reminder. The user can order e-mail reminders for scheduled pay-per-view programs using the system. The user can also have reminder information periodically updated and available directly on the user's multimedia system.

### CROSS-REFERENCE TO RELATED APPLICATION

This application is a continuation of U.S. patent application Ser. No. 10/933,689, filed Sep. 3, 2004, which is a continuation of U.S. patent application Ser. No. 08/987,740, filed Dec. 9, 1997, which is a continuation-in-part of U.S. patent application Ser. No. 08/938,028, filed Sep. 18, 1997, which are incorporated herein in their entireties.

### BACKGROUND OF THE INVENTION

This invention relates to the Internet, and more particularly, to techniques for reminding a user via electronic mail (e-mail) of scheduled television programs displayed on an Internet television program guide.

Cable, satellite, and broadcast television systems provide viewers with a large number of television channels. Viewers have traditionally had to consult preprinted television program listings to determine which programs were scheduled to be broadcast on a particular day and at a particular time. Technological advances have allowed more convenient and advanced program guide services to be developed. For example, passive television-based program guides have been developed that allow television viewers to view television program listings directly on their television sets. In addition, interactive television program guide services have been developed that allow a service provider to deliver television program listings data to a user's set-top box. An interactive program guide application in the set-top box allows the user to display the television program listings on the user's television set. More recently, television program guide systems have been developed that provide television program listings over the Internet.

With such an Internet television program guide system, users with personal computers or integrated personal computers and televisions (PC/TVS) can obtain television program listings on-line. In addition, the users of Internet television program guides are able to view promotional video clips, interview segments, audio clips, and other multimedia material related to a given television program.

Although Internet television program guides provide users with a number of useful features, users are still faced with the problem of missing the television programs that they desire to watch because of not remembering when the program is to be broadcast on television. Users must often refer back to the program listings to determine when desired programs are to air.

It is therefore an object of the present invention to provide a way to remind users of Internet television program guides when certain television programs are to be aired.

### SUMMARY OF THE INVENTION

This and other objects of the invention are accomplished in accordance with the principles of the present invention by providing an Internet television program guide electronic-mail (e-mail) reminder system. The system sends e-mail messages to users to remind the users when selected television programs are to be aired.

Television program information and related data for an Internet television program guide are provided to a web server from a computer system which may be maintained by a service provider. The web server provides this information to the user's multimedia system via an Internet communications link. The user's multimedia system may include a personal computer, an integrated personal computer and television, or an Internet capable set-top box and a television.

The program information and related data are preferably provided to the user's multimedia system in the form of one or more web pages. Program guide listings may be displayed in a grid format organized in channel order from top to bottom and by broadcast time from left to right. Web browser cursors allow the user to scroll through the listings to locate programs at different times in the day or different days in the month.

If a user selects a program or pay-per-view event from the program listings, additional information related to the program or event may be displayed in a program information box. In addition to viewing further information on the program selected, the user may order an e-mail reminder message to remind the user when the selected program will be broadcast. Options are provided that allow the user to determine when and how many messages will be generated and received. Before the scheduled broadcast time of each selected program, the system sends an e-mail message to the user that reminds the user of the program.

If desired, the user may order e-mail reminder messages without first viewing the program listings. This may be accomplished by directly entering the title of a television program for which reminders are to be ordered. This approach is useful when the user knows the program title and does not wish to consult the program listings or when the user knows the program title but does not know the location of the program in the program listings.

The user may also view a list of all currently requested e-mail reminders. Information such as the program name, type of e-mail reminder, and the date and time the request was submitted may be displayed on the list for each reminder. Entries may be added to the current reminder list as soon as the user submits a new request. In addition, the user may cancel reminder entries if the user no longer wishes to be reminded of that program.

In another aspect of the invention, e-mail reminder messages may be ordered and generated to remind a user when scheduled pay-per-view programs will be broadcast.

In yet another aspect of the invention, e-mail reminders may be ordered and generated based on other preferences which the user can specify.

Further features of the invention, its nature and various advantages will be more apparent from the accompanying drawings and the following detailed descriptions of the preferred embodiments.

### BRIEF DESCRIPTION OF THE DRAWINGS

FIG. 1 is a diagram of an Internet television program guide system in accordance with the present invention.

FIG. 2 is a diagram of an illustrative web page containing television program guide listings and e-mail reminder options in accordance with the present invention.

FIG. 3 is a diagram of an illustrative e-mail reminder page that allows a user to enter information for ordering e-mail reminders in accordance with the present invention.

FIG. 4 is a diagram of an illustrative program information web page that contains information on a program selected by the user and that allows the user to order an e-mail reminder in accordance with the present invention.

FIG. 5 is a diagram of an illustrative e-mail reminder page that allows the user to enter more specific information for ordering e-mail reminders in accordance with the present invention.

FIG. 6 is a diagram of an illustrative e-mail reminder message in accordance with the present invention.

FIG. 7 is a diagram of an illustrative e-mail reminder page listing all current e-mail reminder orders in accordance with the present invention.

FIG. 8 is a diagram of an illustrative e-mail reminder page that allows a user to enter a program title and to select among various options when ordering an e-mail reminder in accordance with the present invention.

FIG. 9 is a diagram of an illustrative web page that allows a user to order a pay-per-view event and an e-mail reminder in accordance with the present invention.

FIG. 10 is a site map showing options that may be selected when ordering e-mail reminder messages via an Internet television program guide in accordance with the present invention.

FIG. 11 is a diagram of an illustrative web page that allows a user to select among various preferences when ordering an e-mail reminder in accordance with the present invention.

FIG. 12 is a diagram of an illustrative e-mail reminder message in accordance with the present invention.

FIG. 13 is a diagram of an illustrative e-mail reminder page that allows the user to specify various program genres when ordering an e-mail reminder in accordance with the present invention.

FIG. 14 is a diagram of an illustrative e-mail reminder page that allows the user to enter an actor when ordering an e-mail reminder in accordance with the present invention.

FIG. 15 is a diagram of an illustrative e-mail reminder page that allows the user to enter an exact title when ordering an e-mail reminder in accordance with the present invention.

FIG. 16 is a diagram of an illustrative e-mail reminder page that allows the user to enter a partial title when ordering an e-mail reminder in accordance with the present invention.

### DETAILED DESCRIPTION OF THE PREFERRED EMBODIMENTS

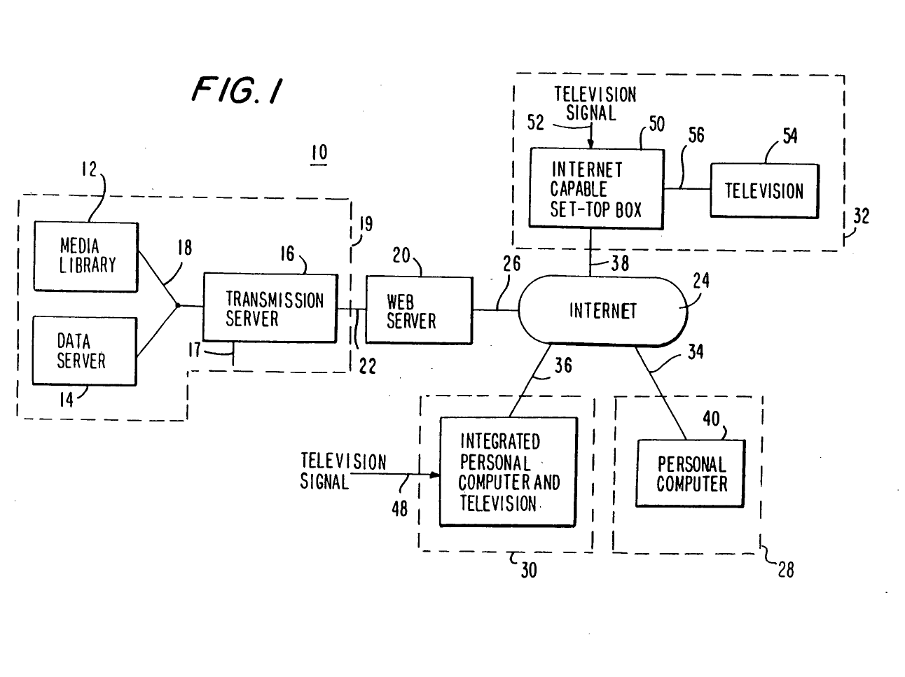

An Internet television program guide system 10 in accordance with the present invention is shown in FIG. 1. Television program information is stored in media library 12 and data server 14. Media library 12 preferably contains an array of compact disc read only memory (CD-ROM) disks, digital video disks (DVDs), or other suitable media for storing multimedia content. Media library 12 contains television program clips and related interviews and reviews. The television program information stored in media library 12 is primarily video-based. Data server 14 maintains various databases of television program information. For example, data server 14 may have a remote media database containing descriptions of videos in media library 12. Data server 14 may also have a database containing information on standard titles, a pay per view database containing information regarding pay-per-view events, and a scheduling information database. Data server 14 may also have a cable system operator database containing channel lineups, information on the time zone of the operator, weather data for the operator's region, data on the zip codes in the cable system operator's area, etc. Other databases may be supported by data server 14, as desired. The television program information in data server 14 is primarily in non-video formats.

Media library 12 and data server 14 may be interconnected with transmission server 16 via internal network 18. Media library 12, data server 14, network 18, and transmission server 16 make up computer system 19. Television program information may be stored on data server 14 in a relational database format and may be stored on transmission server 16 in an object-oriented database format. A building process may be used to periodically (e.g., once a day) build a temporary data set of television program information (e.g., a seven-day to one-month data set) for storage on transmission server 16. Transmission server 16 may receive information for the Internet television program guide service such as weather data, sports scores, etc., via data input 17.

Television program information and related data may be transferred from transmission server 16 to web server 20 via communications link 22. Communications link 22 may be part of an internal network or may be a standard dedicated communications link. Web server 20 may be connected to the Internet 24 via communications link 26. Communications link 26 is preferably a telephone line or other suitable Internet communications path.

If transmission server 16 and web server 20 are separate devices, as shown in FIG. 1, transmission server 16 can be used as a common data processing facility for other applications which use the type of television program data stored on transmission server 16. If desired, the functions of transmission server 16 and web server 20 can be integrated in a single machine. The web server configuration of FIG. 1 is illustrative only. Any other suitable web server configuration may be used if desired. For example, web servers that are located at the facilities of able system operators may be used in conjunction with or instead of web servers such as web server 20.

Web server 20 uses standard protocols such as the TCP/IP (Transmission Control Protocol/Internet Protocol) and hypertext transfer protocol to make the television program information available over the Internet 24 to users at various multimedia systems such as multimedia systems 28, 30, and 32 via communications links 34, 36, and 38. Communications links 34, 36, and 38 are Internet links formed from telephone lines, radio-frequency (RF) links, cable modem links, satellite dish links, combinations of links such as these, or any other suitable Internet connection paths.

Multimedia system 28 has personal computer 40 with Internet access provided via Internet communications link 34.

Multimedia system 30 has an integrated personal computer and television 46, such as the Gateway 2000 Destination® PC-TV hybrid available from Gateway 2000 Inc. of North Sioux City, S.D. Television signals are provided at input 48. Internet access is provided via Internet communications link 36.

Multimedia system 32 has an Internet capable set-top box 50. Set-top box 50 may use the TV OnLine® set-top box application software of WorldGate Corporation, which may be implemented on set-top boxes such as the CFT-2200® of General Instrument Corporation of Hatboro, Pa. and the 8600x® of Scientific Atlanta of Atlanta, Ga. Set-top box 50 receives television signals via input 52. Internet access is provided via Internet communications link 38. Video display signals containing television and Internet information are provided to television 54 via path 56.

During operation of system 10, certain data processing functions, such as user-initiated searches and sorts, are typically performed on web server 20. If desired, such functions can be performed on a suitable data processing component in multimedia system 28, 30, or 32.

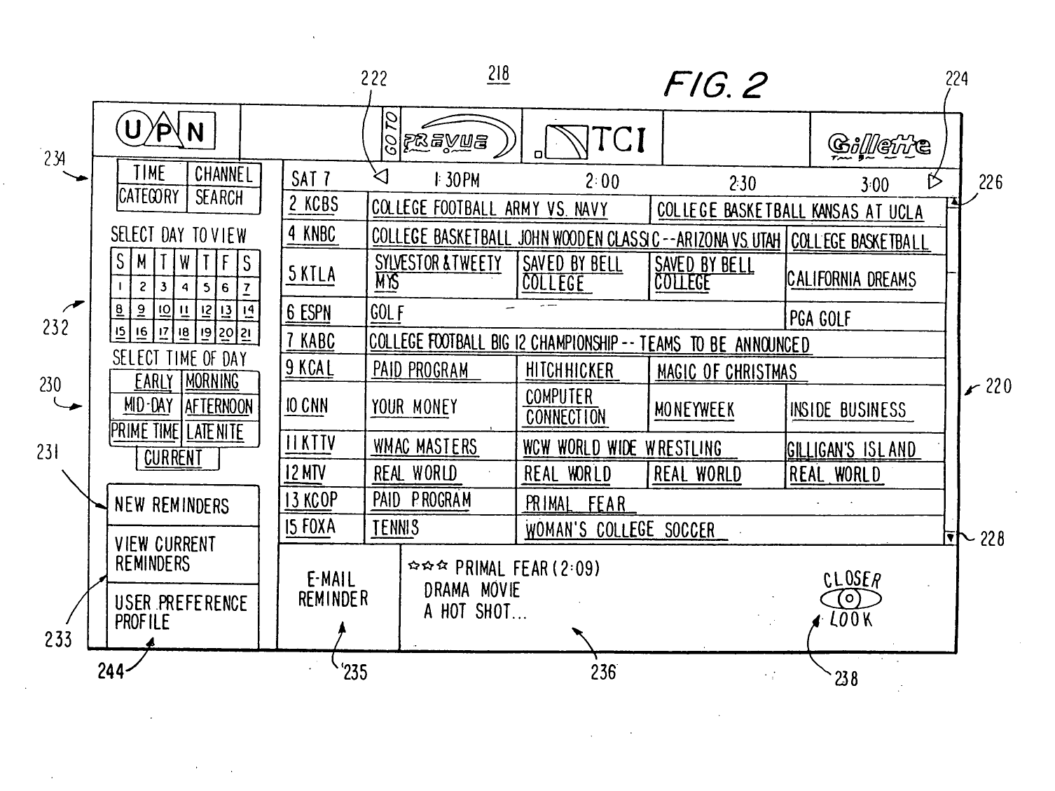

A typical Internet television program guide system display that may be provided using systems 28, 30, and 32 is shown in FIG. 2. Display 218 contains program listings 220 that are organized in channel order from top to bottom and by broadcast time from left to right. Cursors 222 and 224 may be used to navigate to earlier or later time periods, respectively. Web browser cursors 226 and 228 allow the user to scroll through the program listings. The user may also navigate through the program listings with time navigation buttons 230 to view program listings for different times in the day. Calendar buttons 232 may be used to view program listings for different days in the month. The user can choose between various available view options by selecting a desired time, channel, category, or search button from among view buttons 234.

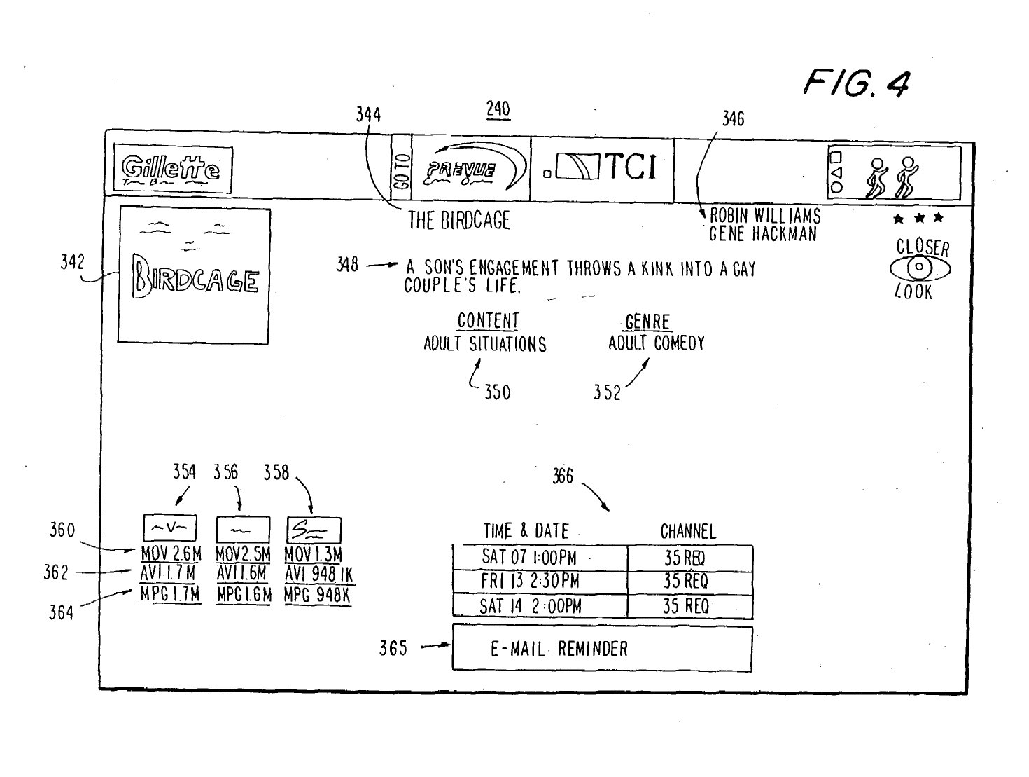

Another component of display 218 is program information box 236. When the user has selected a program or pay-per-view event from program listings 220, additional information related to the program or event is displayed in program information box 236. For example, the user has clicked on the entry “Primal Fear” in program listings 220 of FIG. 2. As a result, the contents of program information box 236 reflects this selection. Program information box 236 typically contains the program title (e.g., Primal Fear), the running time of the program (e.g., 2:09), a brief description of the program (e.g., A hot shot . . . ), and a description of the program type or genre (e.g., drama movie). If the user desires to view additional information relating to the selected program, the user may click on “closer look” icon 238 (or alternatively, on any portion of box 236), which takes the user to program information page 240 (FIG. 4). Program information page 240 allows the user to obtain additional information such as video clips and interview segments on the selected program.

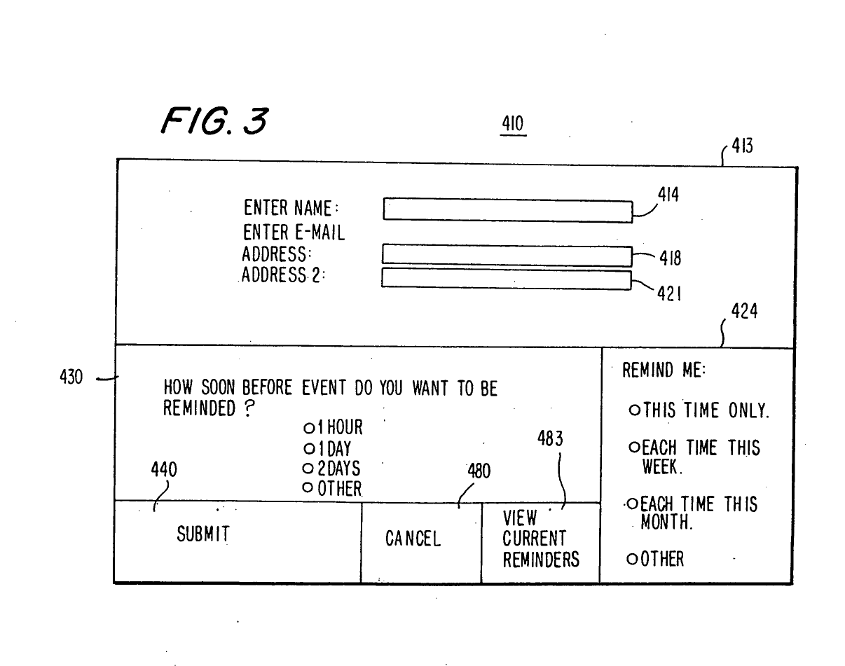

Another component of program information box 236 is e-mail reminder box 235. This box is displayed concurrently with program information box 236 whenever the user has selected a program or event from program listings 220. If e-mail reminder box 235 is selected, the user is presented with an e-mail reminder page such as e-mail reminder page 410 of FIG. 3. E-mail reminder page 410 contains user-selectable options that the user may complete when ordering an e-mail reminder message to remind the user when a particular television program is to be broadcast. As defined herein, such uses of the term “broadcast” refer to the process of airing television programs by traditional television broadcast techniques, cable systems, or satellite systems.

Fields 414 and 418 of e-mail reminder page 410 allows the user to enter the name and e-mail address, respectively, of the person the e-mail reminder message is to be sent to. If desired, the user's name and e-mail address may be automatically entered in fields 414 and 418 based on information previously provided to the system (e.g., information provided when the user registered with the Internet television program guide service).

If the user is browsing program listings from a computer located at the user's office, the user may wish to have e-mail reminders addressed to his home (i.e., using his personal Internet access account and the e-mail address for the multimedia system at home). Alternatively, the user may wish to have e-mail reminders sent to an office e-mail address. If the user has a common e-mail address for both home and the office, e-mail reminders may be accessed at either location. If desired, the system may provide more than one field 418 (e.g., field 421) so that e-mail reminders may be sent to more than one e-mail address.

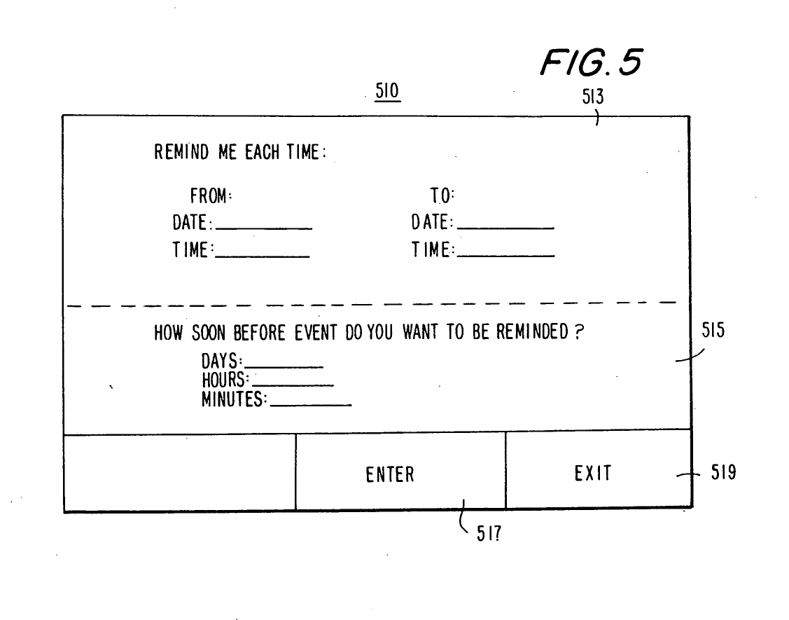

E-mail reminder page 410 may provide several user-selectable options that specify when and how often the user will be reminded of the airing of selected television programs. For example, e-mail reminder page 410 may contain remind me box 424. Selecting an option in remind me box 424 allows the user to specify how often the system will generate and send a reminder message for the user. As shown in FIG. 3, the options in remind me box 424 may allow the user to be reminded of the selected program only once, each time the program is broadcast in a week, each time the program is broadcast in a month, or at some other specified time. If “other” in remind me box 424 is selected, the user is presented with page 510 shown in FIG. 5. Page 510 allows the user to specify the time period during which reminder messages will be generated and sent. The user may specify a time period by completing box 513.

E-mail reminder page 410 of FIG. 3 may also contain how soon box 430. Selecting an option in box 430 allows the user to indicate how soon before the broadcast of the scheduled program reminder messages are to be generated and sent to the user. As shown in FIG. 3, box 430 may contain options that allow the user to be reminded 1 hour, 1 day, 2 days, or another amount of time before the selected program is broadcast. If “other” is selected in box 430, the user is presented with page 510 of FIG. 5, which allows the user to specify a desired lead time before a scheduled event by completing box 515.

Upon completing page 510 of FIG. 5, the user may submit the information that has been entered by selecting enter button 517. The user may exit page 510 without submitting the information by selecting exit button 519. If the user selects either enter button 517 or exit button 519, the user is returned to e-mail reminder page 410.

The options the user selects in boxes 424 and 430 of page 410 determine, respectively, how often and when e-mail reminder messages will be sent. For example, a user may select a program from program listings 220 (FIG. 2) that will be broadcast five times during the upcoming week. When the user selects e-mail reminder box 235 of FIG. 2, the user is then presented with e-mail reminder page 410 of FIG. 3. If the user selects the “1 hour” option in box 430 and the “each time this week” option in remind me box 424, the user will receive five e-mail reminder messages (assuming fields 414 and 418 are completed with the user's own information) 1 hour before each broadcast of the program during that week. The messages may be sent from web server 20 to the user's multimedia system using standard e-mail techniques.

At any time during the completion of e-mail reminder screen 410 (FIG. 3), the user may cancel the e-mail reminder order by selecting cancel box 480. Selecting cancel box 480 returns the user to display 218 of FIG. 2.

Upon completing reminder screen 410, the user may submit a reminder order for processing by selecting submit box 440. Selecting submit box 440 directs the user's multimedia system 28, 30, or 32 of FIG. 1 to send the order to web server 20 (or another such suitable web server) via communications links 34, 36, or 38, Internet 24, and communications link 26. The order is processed and a reminder message is generated by web server 20 and transmitted to the user's multimedia system by e-mail at the appropriate time. Depending on the television program and user-selectable options selected, the user may request and receive one or more e-mail reminder messages.

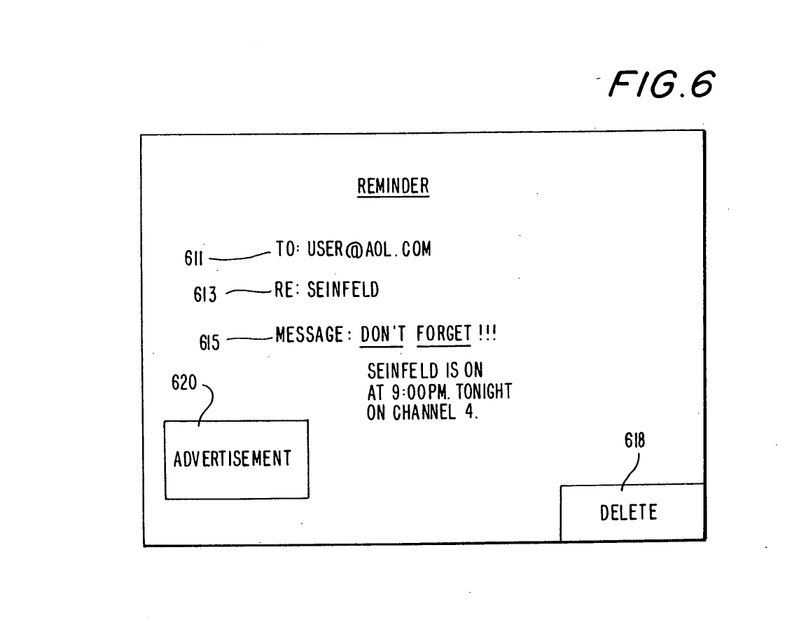

A typical e-mail reminder message is shown in FIG. 6. The message may display the e-mail address of the person the message is being sent to (611), the name of the television program that the person is being reminded of (613), and a reminder message indicating “DON'T FORGET” along with information on when the television program is to broadcast (615). The user may delete the message by selecting delete button 618. An advertisement 620 (text, graphics, etc.) may be included in or attached to the reminder message if desired. The advertisement may be provided using information stored in computer system 19.

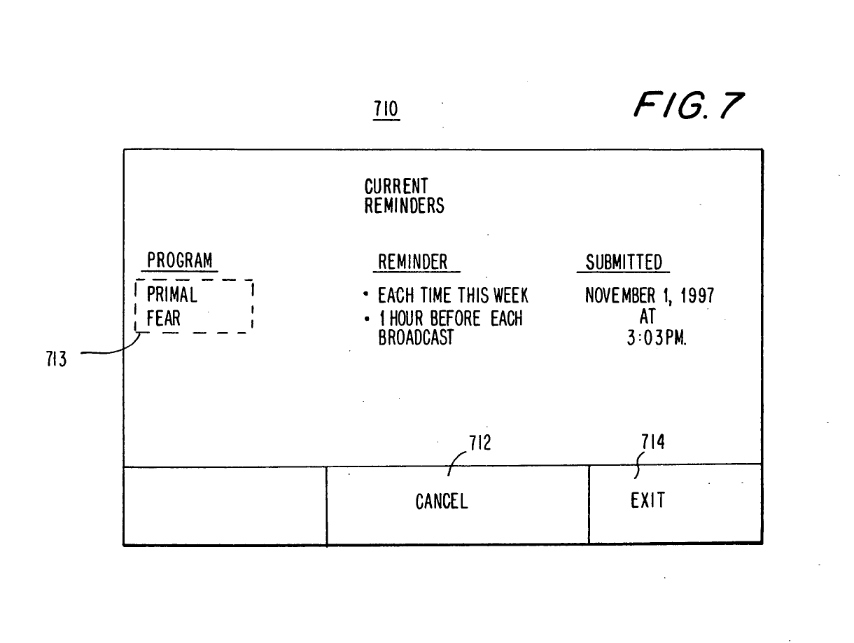

Another aspect of the invention relates to managing one's reminders. If desired, e-mail reminder page 410 of FIG. 3 may contain view current reminders box 483. If view current reminders box 483 is selected, the user may be presented with current reminders page 710 of FIG. 7. Current reminders page 710 contains a list of all the user's currently requested e-mail reminders. Information such as the program name, type of e-mail reminder, and the date and time submitted may be displayed.

For example, a current reminder entry for the program “Primal Fear” may be displayed as shown in FIG. 7. This reminder was submitted by the user on Nov. 1, 1997 at 3:03 p.m. and is set to remind the user one hour before each broadcast during the week beginning Nov. 1, 1997. Entries may be added to the current reminder list as soon as the user submits each request (e.g., by clicking on submit button 440 from e-mail reminder page 410 of FIG. 3). If the user wishes to cancel a current reminder that the user has previously ordered, the user may highlight the desired entry on the screen with highlight region 713 and click on cancel button 712. After clicking on cancel button 712, the highlighted entry is deleted from the current reminder list and the user will no longer be reminded of the broadcasts of that program. The user may return to page 410 by clicking on exit button 714.

Another way that the user may reach e-mail reminder page 410 of FIG. 3 is by clicking on e-mail reminder button 365 in program information page 240 of FIG. 4. Another way that the user may reach current reminders page 710 of FIG. 7 is by clicking on view current reminders button 233 in display 218 of FIG. 2.

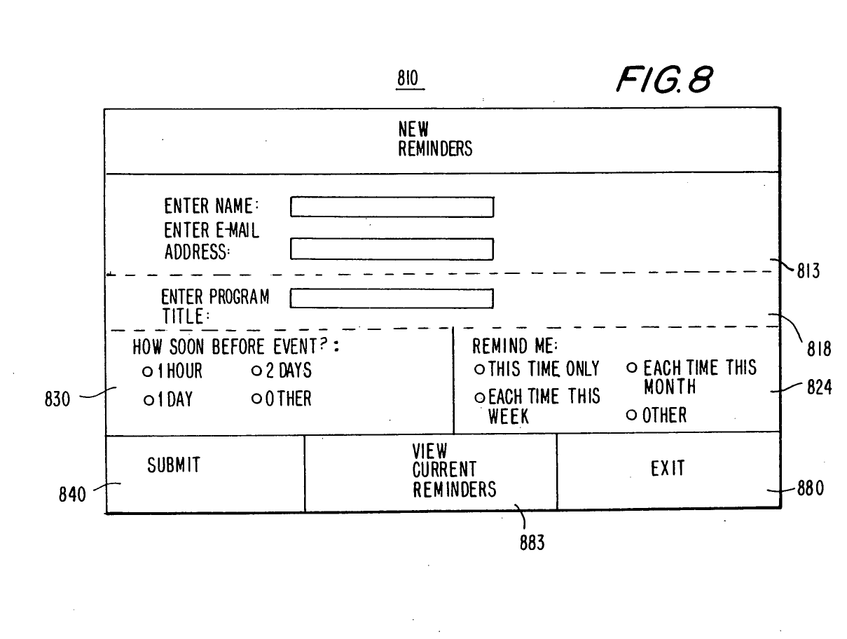

Another component of display 218 is new reminders box 231. New reminders box 231, which may be adjacent to the program navigation controls of display 218, allows the user to order e-mail reminder messages without using program listings 220. If new reminders box 231 is selected, the user is presented with new reminders page 810 of FIG. 8. New reminders page 810 contains user-selectable options similar to the options contained in e-mail reminder page 410 of FIG. 3. For example, new reminders page 810 contains a user information box 813, a how soon box 830, and a remind me box 824. However, new reminders page 810, allows the user to enter the title of a television program for which reminders are to be ordered directly in box 818 without searching program listings 220. This is useful when the user knows the program title and does not wish to consult program listings 220 or when the user knows the program title but not know the location of the program in program listings 220.

If the user does not enter the exact title of the television program in new reminders screen 810, the data of program listings 220 or any other suitable set of television program listings data may be scanned to find the program or programs that most closely match the program title indicated by the user. If several matches are found, a list of the program matches may be presented to the user and the user may choose the actual program desired. Once the user has chosen a program from the list, the program title in box 818 may be automatically updated.

The user may exit new reminders screen 810 at any time by clicking on exit button 880. Selecting exit button 880 will return the user to display 218 of FIG. 2.

Upon completing new reminders screen 810, the user may submit the reminder order for processing by selecting submit box 840. Selecting submit box 840 allows program guide system 10 (FIG. 1) to process the request. The request may be processed in the same way a reminder request may be processed when ordered from reminder screen 410 of FIG. 3.

The user may reach current reminders page 710 of FIG. 7 from new reminders page 810 of FIG. 8 by clicking on view current reminders button 883.

E-mail reminder messages may also be ordered and generated to remind the user of when scheduled pay-per-view programs will be broadcast. Program information page 240 of FIG. 4 contains information related to the program selected by the user on previous pages. For example, if the user has selected a pay-per-view event from program listings 220 and then selects the closer look icon 238, program information page 240 will contain more information relating to that pay-per-view event.

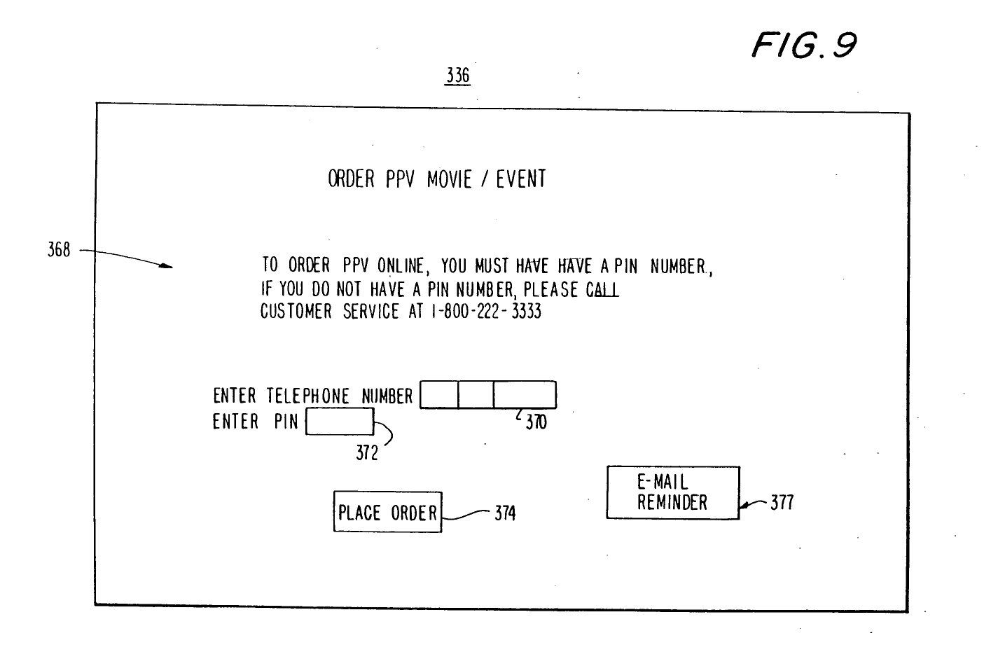

Program information page 240 of FIG. 4 contains program listings 366, which provide title, channel, and time and date information for the selected program. If the user has selected a pay-per-view event in order to arrive at program information page 240, program listings 366 displays additional broadcast information for that pay-per-view program. When the user clicks on a pay-per-view entry in program listings 366, the user is taken to order page 336 (FIG. 9).

As shown in FIG. 9, order page 336 contains instructions 368 on how to order a pay-per-view event. Order page 336 also contains telephone number query box 370 and personal identification number box 372. The user may place an order for a pay-per-view event by clicking on place order button 374. Information entered by the user into boxes 370 and 372 may be used to verify the user's identity and account status. Once the user's information has been verified, the selected pay-per-view event may be delivered to the user's multimedia system.

The user may request an e-mail reminder message for the selected pay-per-view event by clicking on e-mail reminder button 377. When the user selects e-mail reminder button 377, the user is presented with e-mail reminder screen 410 of FIG. 3. After the user has completed e-mail reminder screen 410, the user may click on submit button 440 to process the request.

The way in which pay-per-view event orders are processed depends on the particular hardware used to deliver such services to the user. In system 10 of FIG. 1, web servers such as web server 20 may be located at cable system headends to receive and process pay-per-view orders submitted using order pages such as order page 336. After processing an order, the web server can direct conventional pay-per-view equipment at the cable system headend to authorize the display of the ordered pay-per-view event using set-top box 50 or a similar integrated component. Selecting pay-per-view e-mail reminder button 377 directs user's multimedia system 32 of FIG. 1 (or a similar set-top box based system) to send the order to the Internet 24 via communications link 38. The order is then transmitted to web server 20 via communications link 26. The order may be processed and the reminder message generated by web server 20, then transmitted to the user's multimedia system 32 by e-mail. Depending on the pay-per-view event and user-selectable options selected, the user may request and receive one or more such e-mail reminder messages for pay-per-view events.

If program information page 240 of FIG. 4 details a pay-per-view event, a pay-per-view e-mail reminder message may be ordered from program information page 240 by selecting e-mail reminder button 365 (FIG. 4). Selecting e-mail reminder button 365 will again take the user to e-mail reminder page 410 of FIG. 3. There the user may place an e-mail reminder order using the same steps used for a non pay-per-view television program reminder request.

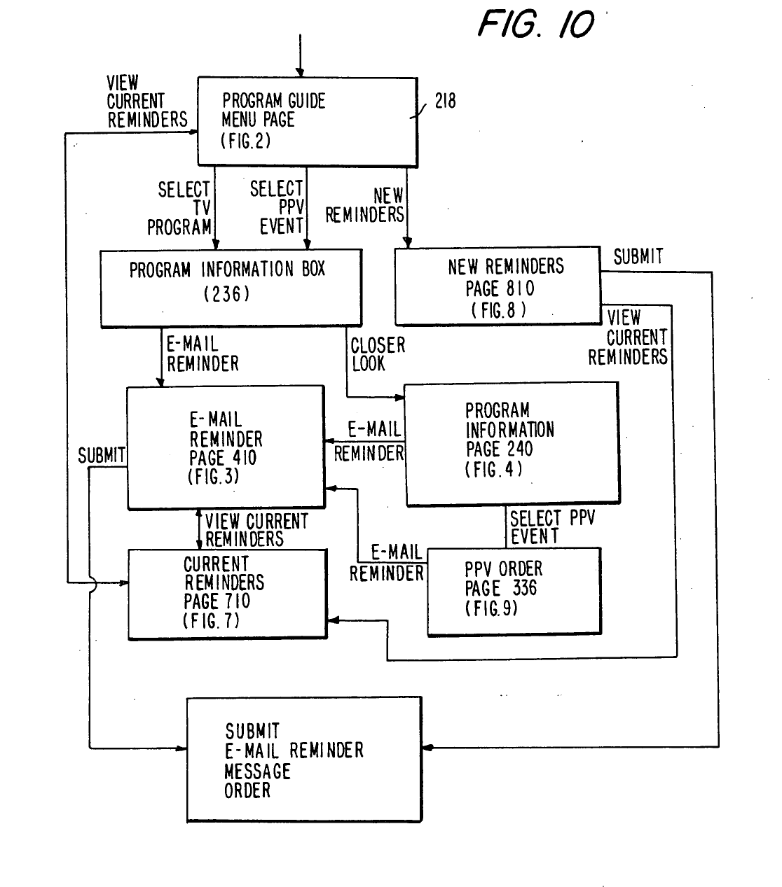

FIG. 10 is a site map showing the interrelationship of the web pages used to provide the features of the e-mail message program reminder service. The service can initially be accessed from the program guide menu page 218 (FIG. 2). When the user selects a scheduled television program, program information box 236 displays information on the selected item and displays e-mail reminder button 235. Similarly, when the user selects a scheduled pay-per-view event, program information box 236 displays information on the selected pay-per-view event and displays e-mail reminder button 235. Selecting the e-mail reminder button from program guide menu page 218 takes the user to e-mail reminder page 410 (FIG. 3). The user, by selecting closer look icon 238 from box 236, is presented with program information page 240 (FIG. 4) which displays further information on the scheduled program or pay-per-view event. The user may also reach e-mail reminder page 410 from page 240 by selecting e-mail reminder button 365.

The user may also access e-mail reminder page 410 and order an e-mail pay-per-view event reminder by selecting e-mail reminder button 377 from pay-per-view order page 336 (FIG. 9). Pay-per-view order page 336 may be accessed from program information page 240.

E-mail reminder page 410 allows the user to submit an e-mail reminder order as well as specify the type of message desired (i.e., when and how many messages are to be sent). The user may submit an e-mail reminder order by selecting submit button 440 (FIG. 3). Once the user submits a reminder order (shown as step 890 in FIG. 10), the reminder is added to current reminders page 710 of FIG. 7. The user may also be taken to current reminders page 710 by selecting view current reminders button 483 (FIG. 3). While at current reminders page 710, the user may view all current reminders and may delete any reminder which is no longer desired. The user may also access current reminders page 710 from program guide menu page 218 by selecting view current reminders button 233 (FIG. 2).

When the user is at program guide menu page 218, selecting new reminders button 231 takes the user to new reminders page 810 (FIG. 8). While at new reminders page 810, the user may enter the desired program title directly by completing field 818. The user may, by selecting view current reminders button 883 (FIG. 8), access current reminders page 710 or submit an order by selecting submit button 840 (FIG. 8).

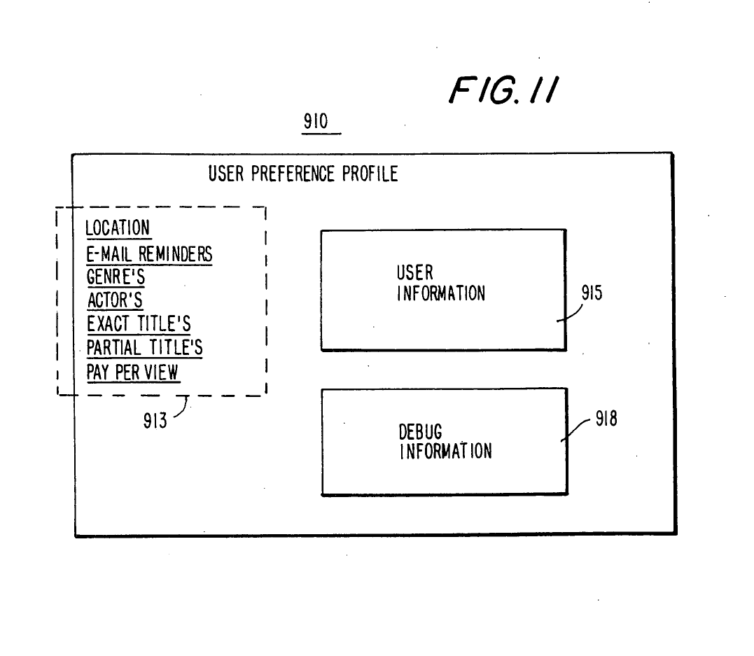

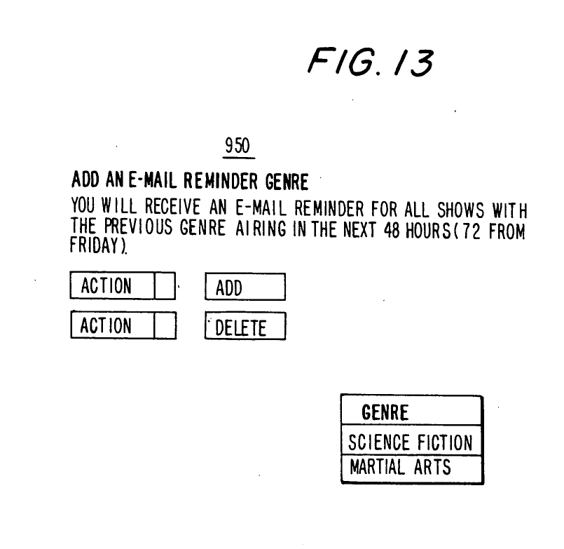

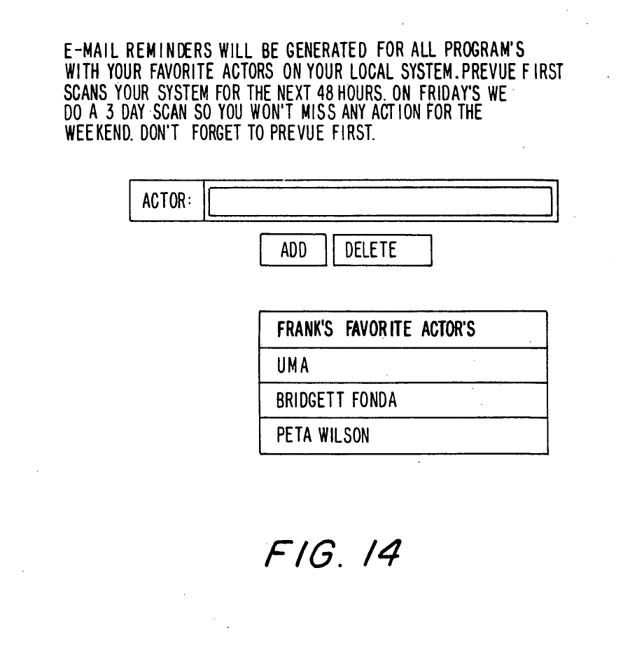

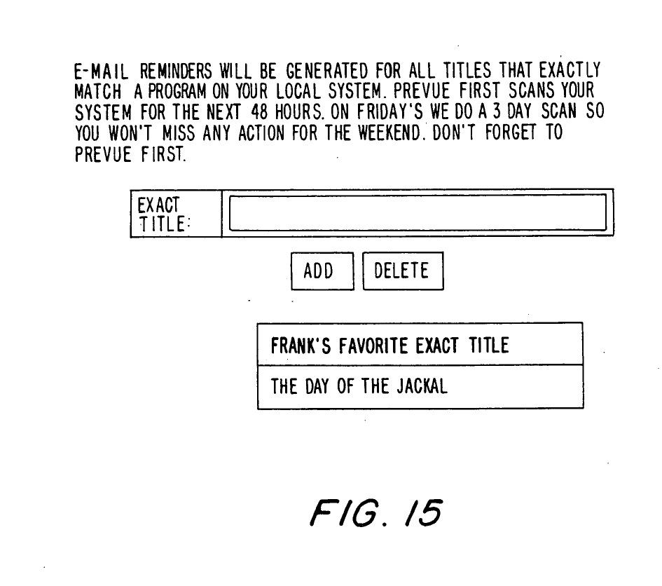

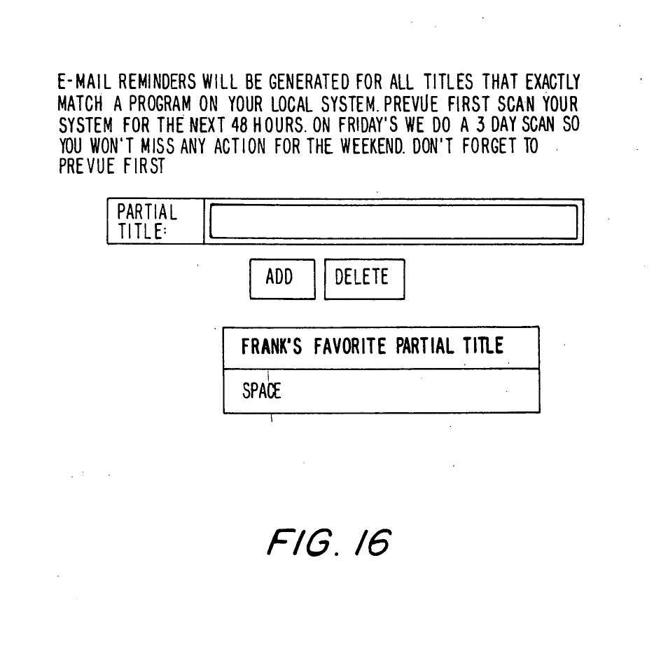

In another aspect of the invention, the user may enter other e-mail reminder preferences by clicking on user preference profile button 244, as shown in FIG. 2. If user preference profile button 244 is selected, the user is presented with user preference profile page 910 of FIG. 11. User preference profile page 910 may contain clickable options 913 allowing the user to further customize e-mail reminder messages that are generated and received. This allows the user to order e-mail reminder messages without using program listings 220 of FIG. 2. For example, if the user clicks on “Genre's” from clickable options 913, the user may be presented with web page 950 of FIG. 13. Web page 950 allows the user to specify a particular genre of television programs for which reminders are to be ordered. The data of program listings 220 or any other suitable set of television program listings data may then be scanned to find the programs having that genre. Similarly, the user may click on “Actor's”, “Exact Title's”, or “Partial Titles” from clickable options 913 whereby the user may be presented with web pages shown in FIGS. 14, 15, and 16, respectively. The user may specify additional preferences to further customize the e-mail reminder message that is generated and received. Also the user may specify a lead time and time period during which reminder messages will be generated and received.

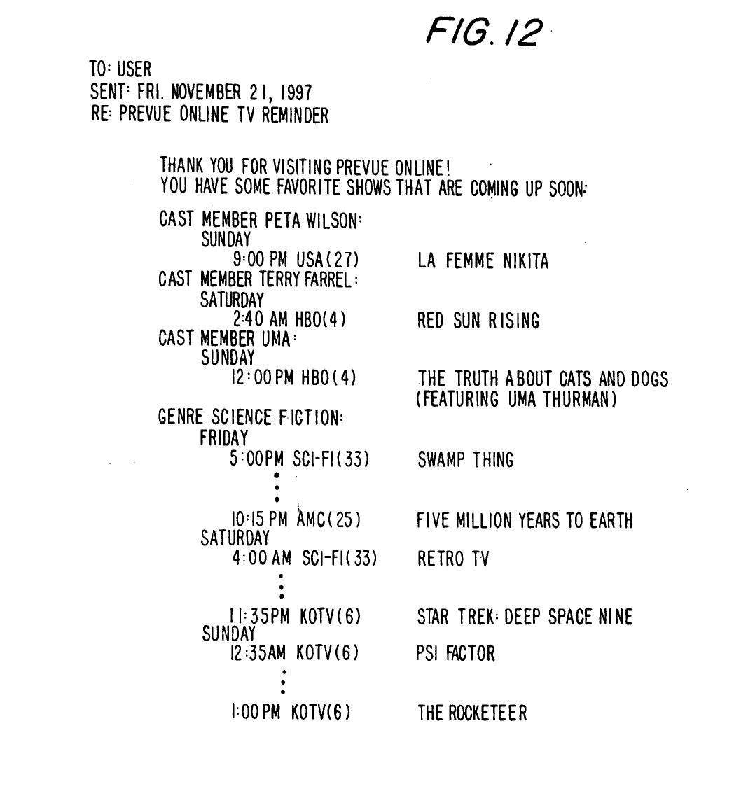

A typical customized e-mail reminder message is shown in FIG. 12. The message may display television programs having the user preferences specified via user preference profile page 910.

In addition, the user may receive the information displayed in the customized e-mail reminder message of FIG. 12 without having to actually receive an e-mail message or actively browse the Internet. The user may (e.g., through an Internet active channel) subscribe to a service that allows the user to receive the customized reminder information and have it available on the user's multimedia system based on user information 915 and debug information 918 of FIG. 11. The user may also request that the reminder information be updated and sent to the user periodically.

The foregoing is merely illustrative of the principles of this invention and various modifications can be made by those skilled in the art without departing from the scope and spirit of the invention.

What is claimed is:

1. A method comprising:
providing television program listings over the Internet;
receiving from a user a selection of a television program from the television program listings provided over the Internet; and
providing at least one e-mail reminder over the Internet that reminds the user when the selected television program is to be broadcast.
